(19) United States
(12) Patent Application Publication
(10) Pub. No.: US 2014/0344808 A1
(43) Pub. Date: Nov. 20, 2014

(54) DYNAMICALLY MODIFYING WORKLOAD PATTERNS IN A CLOUD

(71) Applicant: International Business Machines Corporation, Armonk, NY (US)

(72) Inventors: Pradipta K. Banerjee, Bangalore (IN); Vijay K. Sukthankar, Bangalore (IN)

(73) Assignee: International Business Machines Corporation, Armonk, NY (US)

(21) Appl. No.: 13/898,041

(22) Filed: May 20, 2013

(51) Int. Cl. G06F 9/455

(52) U.S. Cl. CPC G06F 9/455
USPC 718/1

(57) ABSTRACT

A method, computer program product, and system are disclosed for modifying a computing environment hosting one or more workload patterns. A computer system obtains a list of deployed workload patterns on a on a computing environment, wherein each workload pattern is configured to support a predefined workload. The computer system identifies an extension to be deployed on a selected pattern from the list of deployed patterns. The computer system deploys the extension on the selected pattern. The computer system informs a user of the computing environment of new billing information based on deployment of the extension.

### BACKGROUND

Embodiments of the disclosure relate in general to a cloud-based environment, and more particularly to dynamically modifying workload patterns in a cloud-based environment.

Generally, cloud computing uses computing resources, for example hardware and software, which are delivered as a service over a network. Cloud computing entrusts remote services with a user's data, software and computation. Cloud providers manage the infrastructure and platforms on which the applications run. End users may access cloud-based applications through a web browser or a light-weight desktop or mobile application while the business software and user data are stored on servers at a remote location.

### SUMMARY

Embodiments of the present are disclosed herein as a method, computer program product, and computer system for modifying an environment of a computing system. The method comprises obtaining a list of deployed workload patterns on a computing system, wherein each workload pattern is configured to support a predefined workload; identifying an extension to be deployed on a selected pattern from the list of deployed patterns; deploying the extension on the selected pattern; and informing a user of the computing system of new billing information based on deployment of the extension.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 depicts a cloud computing node according to an illustrative embodiment;

FIG. 2 depicts a cloud computing environment according an illustrative embodiment;

FIG. 3 depicts abstraction model layers according to an illustrative embodiment;

FIG. 4 is an illustrative embodiment of a system for modifying workload patterns; and

FIG. 5 is a flowchart illustrating operation of the method in accordance with an illustrative embodiment.

### DETAILED DESCRIPTION

The illustrative embodiments provide a mechanism for dynamically modifying workload patterns in a cloud, and more specifically in a cloud-based environment.

Recently, integrated systems were announced, by a number of organizations, that are specifically designed and tuned for transactional web and database applications. Workload patterns enable one to customize a solution to deliver expertise from a broad ecosystem, and are deployable in an efficient manner, delivering faster time to value.

Patterns in general describe the logical configuration of both the physical and virtual assets that comprise a particular solution. The use of patterns allows an organization to construct a deployable solution one time, and then dispense the final product “on demand”. In other words, the patterns are a set of dependent virtual machines, with defined configuration, that are packaged together to support a single application workload. For example, a shopping cart pattern may consist of two (2) VMs (virtual machines), one VM providing web based and application server functionality and the other VM providing database functionality. The dependencies between the two VMs, initial configuration, etc., are configured, for example, using tools like an activation engine. The patterns can also be cloned and customized to suit one's specific needs.

One of the shortcomings of any current pattern based workload deployment approach is lack of dynamic extensibility or modification of the deployed pattern. For example, if there is a need to add an analytics module to the shopping cart pattern, currently the only solution is to modify the pattern description by editing the existing pattern description. Such editing would occur offline to create a new pattern adding another VM that provides analytics functionality.

If, for example, a user desires to extend an existing VM with a new or updated software bundle, the user would have to first capture the existing image and update (extend) the captured image with the bundle. The updated image would subsequently be imported into a cloud deployment image library, for example, and access given to users of the cloud system to provision the image. In this scenario, the process can be viewed as a three-step solution: i) capture, ii) extend, and iii) import. In the case of patterns deployed to multiple VMs and/or utilizing multiple VMs, this three step process can become substantially more complicated.

This disclosure provides a way to dynamically extend a deployed pattern by way of extensible features or policies, thereby improving business agility and customer experience, while enhancing user experience in a cloud-based environment. As used herein, an “extension” refers to an additional feature, policy, or software package that may be included in a deployed pattern.

Techniques are described whereby power savings and power management are monitored in a host system running multiple virtual machines, and these VMs serve as a variable component in cloud usage for dynamically modifying the workload patterns. It should be understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

The illustrative embodiments also support fair distribution of power savings by dynamically modifying workload patterns in consultation with the user or, in one embodiment, without any human intervention. Accordingly, one or more VMs may be provisioned on a target cloud host in response to resource requests from one or more customer devices. Host power savings and power management on the target host are monitored while the workload patterns are changed dynamically. Power savings determined can be used in determining per-customer cloud usage and can enhance user experience.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models. Characteristics for example are as follows and not limited to the following:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows and not limited to:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

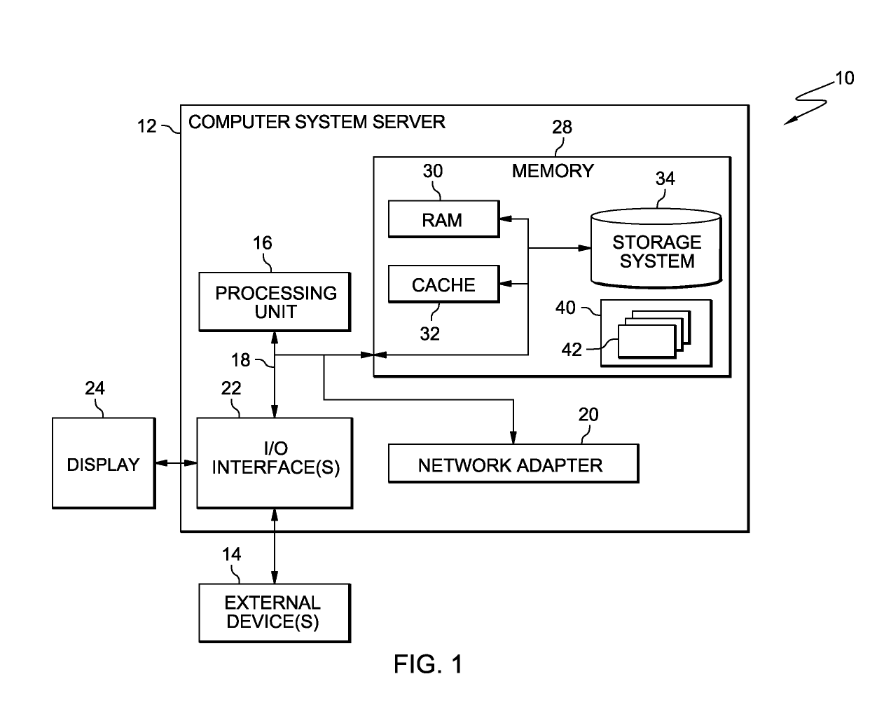

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein. Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

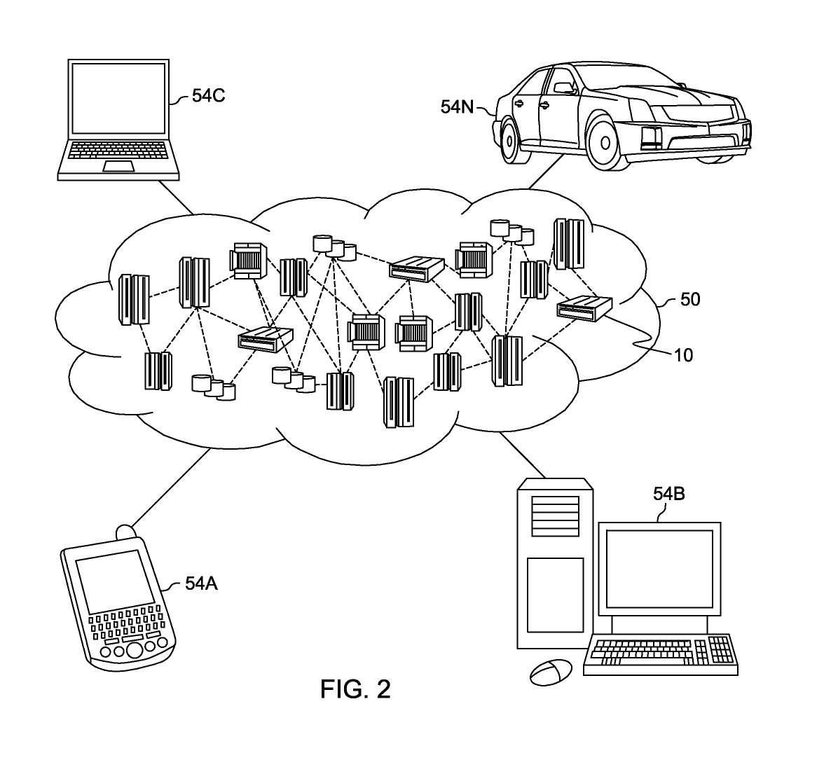

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

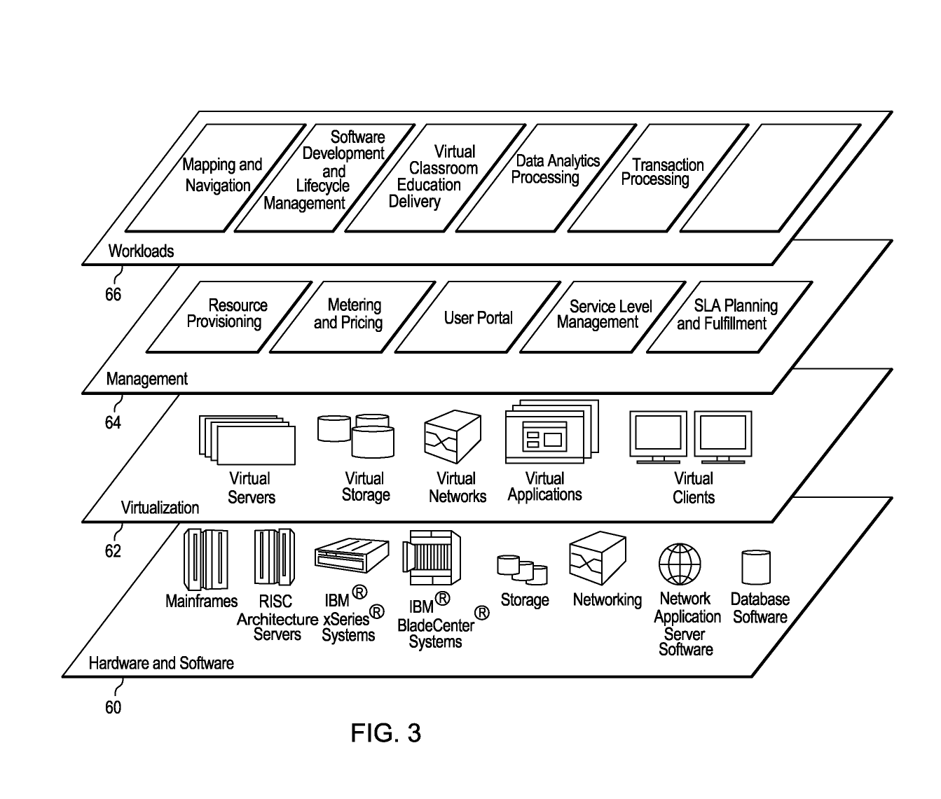

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; and transaction processing.

Embodiments of the present invention may provide a list of extensions (e.g., features and/or policies) that can be applied to an entire deployed pattern or part of the deployed pattern, based on all or any combination of the following: metadata of the deployed pattern, including type of VMs (e.g., web server, app server, etc.), type of pattern (e.g., CRM, ERP, etc.), product details (e.g., db vendor, version or web server vendor, version) and static policies; heuristics and insights from deployed pattern usage; and runtime policy extensions, including Power Savings, HA, DR, and load balancing.

The list can be pre-populated with some initial choices based on using all or some combination of the aforementioned parameters, or can be updated and built at run-time.

The user can select a type of extension required, and the same gets effectuated for the deployed pattern. Similarly the user can remove a deployed extension from a workload once objectives are fulfilled. A modified workload may be saved as a ‘new’ pattern. In one embodiment, the existing showback or chargeback model for the pattern may be updated to account for the extension.

As will be appreciated by one skilled in the art, embodiments of the present invention may be embodied as a system, method, or computer program product. Accordingly, aspects/embodiments of the present invention may take the form of an entirely hardware embodiment, an entirely software embodiment (including firmware, resident software, microcode, etc.) or an embodiment combining software and hardware aspects that may all generally be referred to herein as a “circuit,” “module,” or “system.” Furthermore, aspects/embodiments of the present invention may take the form of a computer program product embodied in any one or more computer readable medium(s) having computer usable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in a baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Computer code embodied on a computer readable medium may be transmitted using any appropriate medium, including but not limited to wireless, wireline, optical fiber cable, radio frequency (RF), etc., or any suitable combination thereof.

Computer program code for carrying out operations for aspects of the present invention may be written in any combination of one or more programming languages, including an object oriented programming language such as Java™, Smalltalk™, C++, or the like, and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to the illustrative embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions that implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus, or other devices to produce a computer implemented process such that the instructions which execute on the computer or other programmable apparatus provide processes for implementing the functions/acts specified in the flowchart and/or block diagram block or blocks.

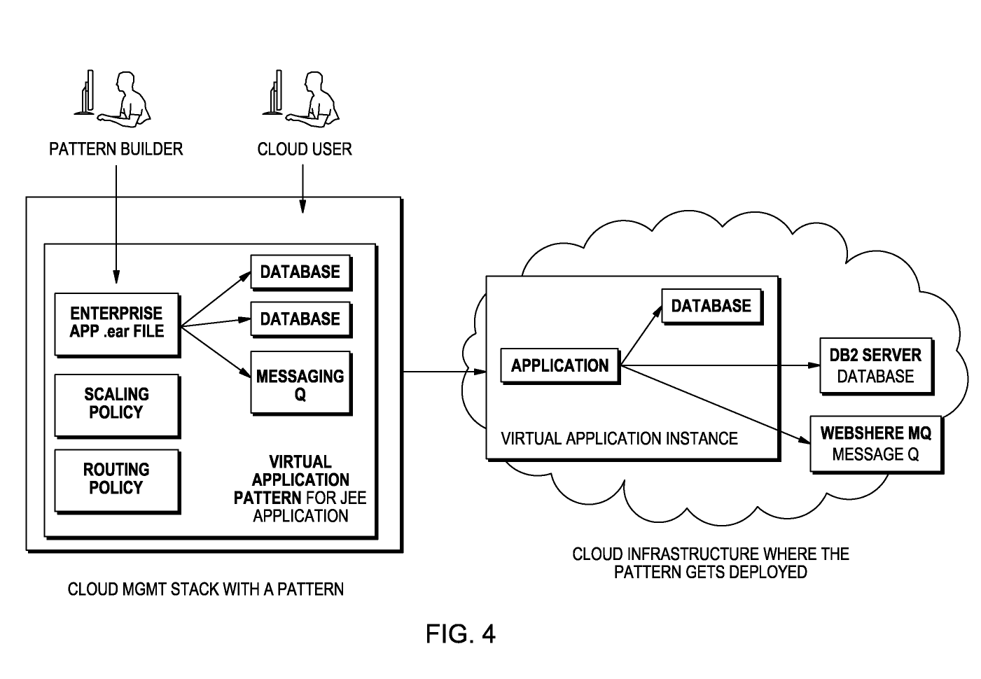

Reference is now made to FIG. 4, which is an illustrative embodiment of a system for dynamically updating a workload pattern. A cloud management platform may operate as a one-stop web application where any user in an enterprise can request a service. Such a platform could be either a deployment of a single VM or a predefined virtual system. A predefined virtual system may be a defined combination of VMs that may be arranged in a pattern, allowing a user flexibility to select and/or deploy resources as defined in the pattern, or to request a modification of resources as allowed by the pattern. A user can create custom images and/or a custom pattern using a pattern constructor. A pattern constructor may also be referred to as a pattern builder. After a pattern is created, a user may deploy the pattern on an infrastructure. Alternatively, a previously stored pattern may automatically deploy.

Illustrated is a cloud management stack with a pattern. The cloud management stack comprises a pattern builder, which may be used by a cloud user to build patterns in real time. In one embodiment, the pattern builder can be used to build patterns and store them in the cloud management stack. Built patterns can be deployed at a desired time automatically. In another embodiment, the pattern builder may build patterns based on previous history usage and store them, or present them to the cloud user for approval before being deployed.

Once the pattern builder builds patterns, these patterns can be deployed on the cloud infrastructure in real time or at a specified time in the future. FIG. 4 illustrates how the pattern builder is used to build new extensions and/or patterns for an existing Virtual Application Instance for a JEE application. For example, applications (functionalities) and policies may be added. The cloud management stack may also have predefined extensions and/or patterns, for example, a Hypervisor Image of the Middleware and Scripts (python, chef, etc.), which may be enabled to create a pattern of clustered nodes of the Middleware after deployment. When the cloud user selects a pattern from a catalog, the cloud management stack may provision the pattern to the cloud managed infrastructure for deployment. A pattern builder may be a user interface where a pattern composition and/or a pattern description can be entered.

Extensions depend on the pattern components to which they apply and the physical environment in which the patterns operate. More specifically, for an extension to be applied to an existing pattern, knowledge of one or more items such as the host system, virtualization software, operating system, and storage connectivity, to name a few, may be necessary. Each extension may be designed to operate in conjunction with the known components of the system running the existing image. In one embodiment, extensions can be previously created in order to properly work with an existing an image, and also have some variable factors that can be set by data collected from operation of the existing VMs. To avoid having to integrate additions or modifications into an existing image or pattern spread across one or more VMs, in one embodiment, an extension may be designed to deploy as a separate VM capable of interacting with the existing image to perform the desired additional functionality. The extension, or versions of the extension dependant on the environment, may then be deployed one or more times in accordance with the original pattern deployment.

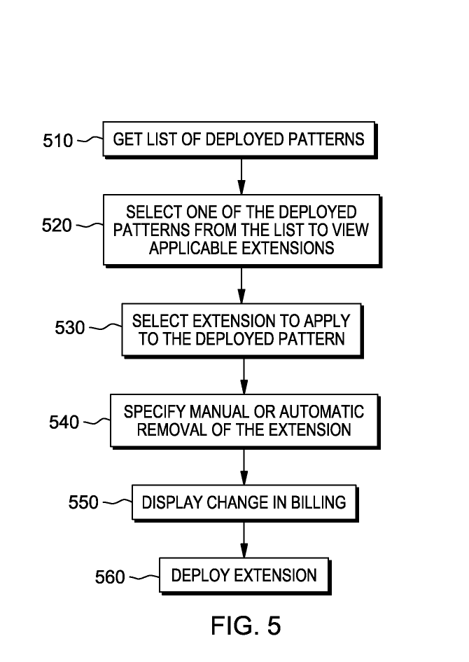

FIG. 5 is a flowchart illustrating operation of the method in accordance with an illustrative embodiment. In step 510 a list of deployed patterns is obtained. In step 520 one of the deployed patterns is selected from the list to view applicable extensions to the deployed pattern. In step 530, the extension to be applied to the deployed patterns is selected. In step 540, it is specified whether manual or automatic removal of the extension is required, which may be based on a specified lifetime of the deployed extension. In step 550, a change in billing information, if applicable, is displayed to the user or approver, and a confirmation is sought for the extension to be deployed. In Step 560, the extension selected is deployed on the cloud infrastructure with appropriate billing modifications being made.

A computing system environment may be altered or fine-tuned by obtaining a list of deployed patterns on the computing system, wherein each pattern has a predefined configuration for supporting a predefined workload. Embodiments of the present invention may identify extensions that can be deployed on a selected pattern from the list of deployed patterns, and subsequently deploy on of the identified extensions. The process may update a user on new billing information for the deployed pattern. For example, by including high availability (HA), load balancing (LB), and energy management details based on, but not limited to, the pattern description of the deployed pattern. A pattern description may include a type of pattern (e.g., web, e-commerce, etc.), details of the pattern (e.g., web server, app server, DB etc.), product details (e.g., database vendor, version, web server vendor, static policies, etc.). In one embodiment heuristics may be used and insights from the deployed pattern usage. Runtime policy extensions may include Power Savings, HA, DR, and load balancing.

In a further embodiment, the pattern may encompass a virtual machine, a group of virtual machines, an application, or a group of applications. In yet a further embodiment the method includes identifying extensions to be deployed on a complete pattern or part of a selected pattern. The process may select at least one deployed pattern from the list of deployed patterns. A list of applicable extensions of the deployed pattern is populated along with the billing information. The applicable extension is chosen and applied to the selected pattern. An applicable extension may be removed from the deployed pattern based on a threshold parameter, wherein the threshold parameter comprises at least one of: lifetime of the extension, billing, resource usage, errors, or other measurable metrics.

In yet a further embodiment, the change in billing information for an applicable extension is transmitted to a user, wherein the applicable extension is applied on receipt of confirmation from the user.

In yet a further embodiment, wherein the system is a cloud, a grid, a cluster, or another network topology, the predefined configuration may comprise a pattern description including deployed types of patterns, pattern details, product details, policies, heuristics from deployed pattern usage, power consumption, load balancing, availability, and/or energy management.

Take, for example, a user selecting a power savings policy for a deployed pattern. The system may make appropriate changes by enabling the power savings policy for the VMs, enabling suitable changes in the billing module to include ‘power’ as a billable component, and applying a suitable power based cost model as per configured rules. The choice of cost model can be either rules/configuration driven or decided by an administrator as part of a typical provisioning workflow.

As another example, a user may select a load balancing policy for a deployed pattern. The system may make appropriate changes by way of provisioning a load balancer, a duplicate copy of the load-balanced service, and dynamic reconfiguration of the IP address.

In yet another example, a user may select a search feature for a deployed database pattern. The system may make appropriate changes by way of provisioning a new VM with search capability and configuring the search application to get data from the DB.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Thus, the illustrative embodiments provide mechanisms for installation of an asset from a marketplace to a cloud server behind an enterprise firewall. The marketplace application is deployed on the World Wide Web and allows customers to register with the marketplace to browse cloud assets. The marketplace may be integrated with multiple content/asset repositories. During registration, every customer is provided a placeholder that resides on the marketplace file system. Customers have components installed on a machine behind the firewall. The components have access to the Internet. A download server is installed in the customer premises behind the firewall. A grabber service connects to the marketplace backend file system. A configuration file includes customer details and provides information for accessing the placeholder.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1-8. (canceled)

9. A computer program product for modifying an environment of a computing system, the computer program product comprising:
one or more computer-readable storage media and program instructions stored on the one or more computer-readable storage media, the program instructions comprising:
program instructions to obtain a list of deployed workload patterns on a computing system, wherein each workload pattern is configured to support a predefined workload;
program instructions to identify an extension to be deployed on a selected pattern from the list of deployed patterns;
program instructions to deploy the extension on the selected pattern; and
program instructions to inform a user of the computing system of new billing information based on deployment of the extension.

10. The computer program product of claim 9, wherein the pattern encompasses one of: a virtual machine, a group of virtual machines, an application, and a group of applications.

11. The computer program product of claim 9, wherein the program instructions to identify the extension to be deployed on the selected pattern comprise program instructions to receive a selection of a deployed pattern from the list of deployed patterns.

12. The computer program product of claim 11, further comprising program instructions, stored on the one or more computer-readable storage media, to, in response to receiving the selection of the deployed pattern, display a list of applicable extensions for the deployed pattern.

13. The computer program product of claim 9, further comprising program instructions, stored on the one or more computer-readable storage media, to remove the deployed extension from the selected pattern in response to meeting a threshold parameter.

14. The computer program product of claim 13, wherein the threshold parameter is selected from the group consisting of: lifetime of the extension, billing, resource usage, and errors.

15. The computer program product of claim 9, further comprising program instructions, stored on the one or more computer-readable storage media, to:
prior to deploying the extension on the selected pattern:
notify the user of the identified extension; and
receive, from the user, confirmation to deploy the extension.

16. A computer system for modifying a computing environment, the computer system comprising:
one or more computer processors;
one or more computer-readable storage media; and
program instructions stored on the one or more computer-readable storage media for execution by the one or more computer processors, the program instructions comprising:
program instructions to obtain a list of deployed workload patterns on a computing environment, wherein each workload pattern is configured to support a predefined workload;
program instructions to identify an extension to be deployed on a selected pattern from the list of deployed patterns;
program instructions to deploy the extension on the selected pattern; and
program instructions to inform a user of the computing environment of new billing information based on deployment of the extension.

17. The computer system of claim 16, wherein the program instructions to identify the extension to be deployed on the selected pattern comprise program instructions to receive a selection of a deployed pattern and, in response, display a list of applicable extensions for the deployed pattern.

18. The computer system of claim 16, further comprising program instructions, stored on the one or more computer-readable storage media for execution by the one or more computer processors, to remove the deployed extension from the selected pattern in response to meeting a threshold parameter.

19. The computer program product of claim 18, wherein the threshold parameter is selected from the group consisting of: lifetime of the extension, billing, resource usage, and errors.

20. The computer program product of claim 16, further comprising program instructions, stored on the one or more computer-readable storage media for execution by the one or more computer processors, to:
prior to deploying the extension on the selected pattern:
notify the user of the identified extension; and
receive, from the user, confirmation to deploy the extension.
